(19) United States
(12) Patent Application Publication
(10) Pub. No.: US 2026/0318412 A1
(43) Pub. Date: Oct. 15, 2026

(54) Actuator for a Parking Lock

(71) Applicant: ZF Friedrichshafen AG, Friedrichshafen (DE)

(72) Inventors: Yannick Lacroix, Friedrichshafen (DE); Markus Moosmann, Grünkraut (DE)

(21) Appl. No.: 19/482,656

(22) PCT Filed: Apr. 16, 2024
(86) PCT No.: PCT/EP2024/060219

§ 371 Date: Nov. 7, 2025

(30) Foreign Application Priority Data
May 8, 2023 (DE) 10 2023 204 222.3

(51) Int. Cl. F16H 63/34

(52) U.S. Cl. CPC F16H 63/3483; F16H 63/3433

(57) ABSTRACT

An actuator for a parking lock in a motor vehicle includes a hydraulic piston in a cylinder, wherein the parking lock is actuatable by the hydraulic piston. The actuator further includes a hydraulic inlet hydraulically connected to the cylinder and a form-fitting locking mechanism for locking the hydraulic piston in a predetermined position. Moreover, the actuator includes an electromagnetic actuation mechanism for releasing the form-fitting locking mechanism, a hydraulic outlet, and a valve in fluid flow between the hydraulic inlet and the hydraulic outlet. The electromagnetic actuation mechanism acts on the valve such that the valve is closed when the form-fitting locking mechanism is released.

### CROSS-REFERENCE TO RELATED APPLICATION

The present application is related and has right of priority to German Patent Application No. 10 2023 204 222.3 filed on May 8, 2023 and is a nationalization of PCT/EP2024/060219 filed in the European Patent Office on Apr. 16, 2024, both of which are incorporated by reference in their entirety for all purposes.

### FIELD OF THE INVENTION

The present invention relates generally to an actuator for a parking lock. In particular, the invention relates generally to an electrohydraulic actuator for a parking lock in a motor vehicle.

### BACKGROUND

A motor vehicle includes a traction motor which acts on a driving wheel. In order to ensure that the stopped motor vehicle does not inadvertently roll away, a parking lock may be provided, which prevents the driving wheel from rotating due to a form fit connection.

An actuator for actuating the parking lock may be hydraulically actuated and electromechanically locked. The hydraulic actuation may be carried out by a hydraulic piston, which is accommodated in a cylinder. Fluid having a predetermined pressure may flow through an inlet. The pressure may act on the piston to drive the piston out of the cylinder. The electromechanical locking mechanism may lock the piston in the cylinder. Only when the locking mechanism has been released may a hydraulically controlled movement be again made possible.

The actuator may be integrated into a fluid circuit, which may be provided for cooling and/or lubricating a further component. For example, the further component may include a transmission or an electric prime mover. The volumetric flow is typically provided by a hydraulic pump. Fluid from the pump may flow through the actuator and, from there, further to a cooling or lubrication point. The pump may provide a high fluid pressure in particular when the fluid is used for the hydraulic control of a further hydraulic actuator, for example a brake or a clutch in a multi-stage transmission.

If such actuators are not available, a high control pressure is not necessary. The pump may be dimensioned smaller in order to provide only one volumetric flow of fluid for cooling and/or lubrication. A maximum fluid pressure may then no longer suffice, however, for safely controlling a hydraulic actuator for a parking lock.

### SUMMARY OF THE INVENTION

A problem addressed by the present invention is to provide an improved actuator for a parking lock in a motor vehicle.

According to a first aspect of the present invention, an actuator for a parking lock in a motor vehicle includes a hydraulic piston in a cylinder, wherein the piston is designed to actuate the parking lock. Furthermore, the actuator has a hydraulic inlet, which is connected to the cylinder, a form-fitting locking mechanism of the piston holdable in a predetermined position, an electromagnetic actuation mechanism to release the form-fitting locking mechanism, and a hydraulic outlet. A valve is also provided, which is arranged between the inlet and the outlet, wherein the electromagnetic actuation mechanism acts on the valve, such that the valve is closed when the locking is released.

Advantageously, the valve may be automatically controlled in an open loop by actuating the locking mechanism. An additional actuation for the valve may be unnecessary. Closing the valve may cause a volumetric flow of fluid flowing through the inlet to back up, such that its pressure increases. As a result, the hydraulic actuation of the parking lock may exert a greater force. In addition, a hydraulic element, which is located downstream of the actuator and is fluidically connected to the outlet, may be decoupled from the pressure increase. The volumetric flow of fluid through the actuator may be interrupted for the process of actuating the parking lock, i.e. releasing or setting the parking lock. This interruption typically lasts for only a short time of, for example, less than one second, such that a disadvantage cannot be created for a hydraulically downstream element. The short interruption may be tolerable in particular when outflowing fluid for cooling and/or lubricating an element aboard the motor vehicle is used.

In a particularly preferred embodiment, the valve has a hydraulic control mechanism and a further valve is provided, which is controllable by the actuation mechanism. The further valve is arranged between the inlet and the control mechanism.

The valve is also referred to as a main valve and the further valve is also referred to as a pilot valve. By utilizing the pilot valve, the electromagnetic actuation may be decoupled from the control of the fluid flow between the inlet and the outlet. As a result, a large volumetric flow is controllable in an improved way with a low force and a small control path. In addition, the mechanical locking of the piston may also still operate when the main valve should be blocked.

Particularly preferably, the further valve is open when the locking is released. Fluid flowing into the inlet may flow through the pilot valve for the open-loop control and close the main valve. A hydraulic pressure of the inflowing fluid may rise and the fluid may drive the piston out of the cylinder. This movement acts on the parking lock, in particular in order to release the parking lock, such that the motor vehicle may travel. The piston is more preferably loaded with an elastic element, which drives the piston back into the cylinder when the hydraulic pressure decreases again.

The electromagnetic actuation mechanism may include an electrical coil and a movable armature. More preferably, the armature is movable along a predetermined axis, such that it is advantageously usable to actuate the locking mechanism and the pilot valve.

An elastic decoupling mechanism is providable between the electromagnetic actuation mechanism and the locking mechanism. As a result, the electromagnetic actuation mechanism may also actuate the control piston of the pilot valve when the locking mechanism stands still.

The form-fitting locking mechanism may include a first and a second element, which are displaceable relative to each other along an axis. The first element may have a cutout and the second element may have an indentation, each of which is designed to accommodate a locking member. A support member, which is displaceable along the axis, is designed to hold the locking member in the indentation according to the position of the support member.

Provided the locking member is situated in the cutout, it establishes a form fit connection between the first and the second element. The support member is displaceable along the axis into a further predetermined position in which its radial support effect on the locking member is nullified. A force acting along the axis, which drives the two elements apart, may exert a shearing action on the locking member, such that this may be driven out of the indentation. As a result, the form fit connection between the first and the second element may be released. An actuation of the parking lock may be carried out by a relative movement of the first element relative with respect to the second element.

Preferably, the first and the second element are formed by concentric cylinders. The support member may be mounted in the inner cylinder. The inner cylinder may correspond to the first element and the outer cylinder may correspond to the second element. The arrangement of the two concentric cylinders with the support member may be a roll closure. Multiple locking members may also be provided on a periphery about the axis, each of which may be situated in respectively associated cutouts or indentations. The locking members are more preferably formed as rollers or balls.

More preferably, one of the cylinders is connected to the piston. The piston may be flush with the cylinder on one side and, for example, be displaceably accommodated in a housing of the actuator.

According to a further aspect of the present invention, an electric drive axle includes a parking lock and an actuator described herein. Preferably, the drive axle also includes a hydraulic pump in order to provide a flow of fluid at the inlet of the actuator. The drive axle may also include a cooling or lubrication point, which is fluidically connectable to the outlet of the actuator. Fluid flowing out of the cooling or lubrication point may be collected and returned to the pump. Preferably, the fluid flows through a heat exchanger in order to be cooled.

According to a further aspect of the present invention, a motor vehicle has an electric drive axle described herein. The motor vehicle may include, in particular, a motorcycle, a passenger car, a truck, or a bus.

### BRIEF DESCRIPTION OF THE DRAWINGS

The present invention will now be described in greater detail with reference to the accompanying figures, in which:

FIG. 1 shows a motor vehicle with an electric drive axle;

FIG. 2 shows an actuator for a parking lock of a motor vehicle in a first position;

FIG. 3 shows the actuator of FIG. 2 in a second position; and

FIG. 4 shows the actuator of FIG. 2 in a third position.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

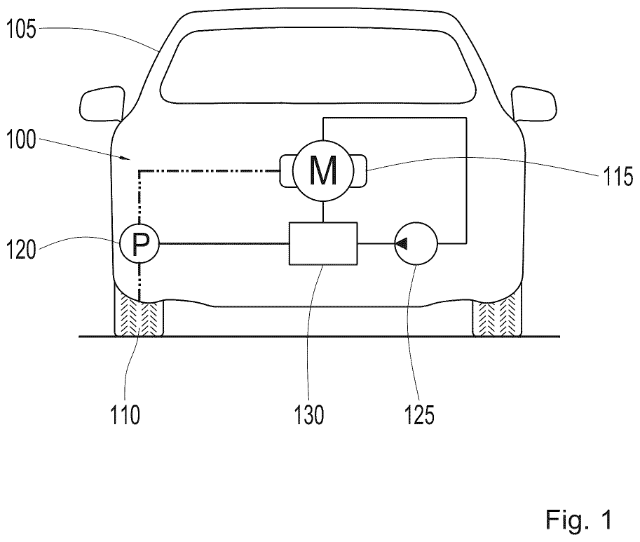

FIG. 1 shows an electric drive axle 100 in a motor vehicle 105 having a driving wheel 110. The drive axle 100 includes an electrical propulsion unit 115, which acts on the driving wheel 110. A rotational motion of the driving wheel 110 is preventable by a parking lock 120. The parking lock 120 typically acts in a form-fitting manner and supports the driving wheel 110 relative to the motor vehicle 105.

A hydraulic pump 125 provides a volumetric flow of fluid, which is usable, in particular, to cool and/or lubricate an element of the electric drive axle 100. The volumetric flow is able to be conducted through a hydraulic actuator 130 for actuating the parking lock 120 to a cooling or lubrication point of the electric drive axle 100. In the schematic view from FIG. 1, the electric machine 115 is shown as a cooling and/or lubrication point. Fluid emerging from the electric machine 115 is transportable back to the pump 125. A radiator, which is typically provided, or a reservoir for fluid are not shown in FIG. 1.

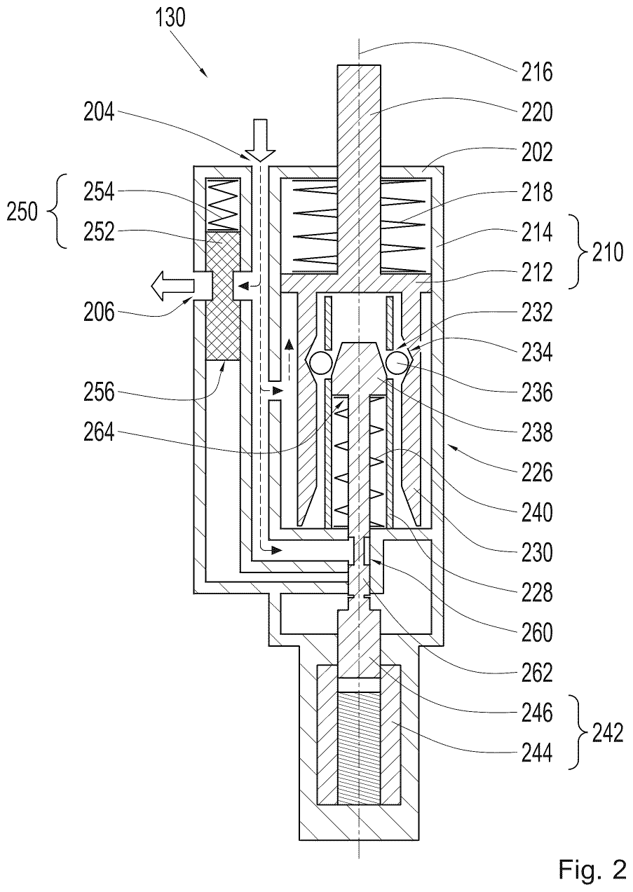

FIGS. 2 through 4 show an actuator for a parking lock 120 in different states of an actuation. The parking lock 120 of FIGS. 2 through 4 is schematically shown and is to be considered merely as an example.

FIG. 2 shows an actuator 130 for a parking lock 120 of a motor vehicle 105 in a first position. The actuator 130 includes a housing 202 with a hydraulic inlet 204 and a hydraulic outlet 206. The inlet 204 is connectable to the hydraulic pump 125 (FIG. 1) and the outlet 206 is connectable, for example, to the electric machine 115 (FIG. 1) of the electric drive axle 100 (FIG. 1). Block arrows symbolize an entering or exiting volumetric flow of fluid. Flows of fluid within the actuator 130 are indicated using dashed lines with arrows.

A hydraulic arrangement 210 includes a piston 212, which is accommodated in a cylinder 214, wherein the cylinder 214 is formed in the present case by a section of the housing 202. The piston 212 is mounted in the cylinder 214 so as to be displaceable along an axis 216. A working space shown underneath the piston 212 in FIG. 2 is fluidically connected to the inlet 204. Fluid in the working space may push the piston 212 upward against the force of an elastic element 218. A push rod 220 may provide a movement of the piston 212 to actuate the parking lock 120.

A locking mechanism 226 holds the piston 212 in the position shown in a form-fitting manner. The locking mechanism 226 includes a first cylinder 228 and a second cylinder 230, which are arranged concentrically about the axis 216. The first cylinder 228 is mounted at a lower end on the housing 202. The second cylinder 230 is mounted at an upper end on the piston 212.

The first cylinder 228 has a radial cutout 232 and the second cylinder 230 has a radial indentation 234. A locking member 236 is forcibly displaced radially toward the outside by a support member 238, such that it is situated in the cutout 232 and in the indentation 234. Preferably, the locking member 236 is a ball or roller. As a result, the locking member 236 establishes a form fit connection between the first cylinder 228 and the second cylinder 230.

The support member 238 is forcibly displaceable along the axis 216 by an elastic element 240 into a position in which it drives the locking member 236 radially outwards as shown.

The support member 238 is movable downward against the force of the elastic element 240 along the axis 216 in the schematic view from FIG. 2 by an electromagnetic actuation mechanism 242. The actuation mechanism 242 includes an electrical coil 244 and an armature 246. In the schematic view from FIG. 2, electric current does not flow through the coil 244, such that the armature 246 rests in the position shown.

A first valve 250, which is also referrable to as a main valve, is provided between the inlet 204 and the outlet 206. The first valve 250 includes, by way of example, a control piston 252, which is accommodated in the housing 202 in an axially movable manner. An elastic element 254 forcibly displaces the control piston 252 into the position shown. A control surface 256 of the control piston 252 is situated opposite the elastic element 254, such that a hydraulic pressure acting there may displace the control piston 252 against the force of the elastic element 254 out of the position shown. The first valve 250 is, for example, a cross-flow valve, which, in the position shown, permits flow to pass from the inlet 204 to the outlet 206.

A second valve 260, which is also referred to as a pilot valve, is provided in a region axially between the locking mechanism 226 and the actuation mechanism 242. It includes a control piston 262, which is accommodated in the housing 202 in an axially movable manner. The control piston 262 is integrable with a connection between the support member 238 and the armature 246. Preferably, an elastic decoupling mechanism 264 is mounted axially between the control piston 262 and the support member 238. As a result, the control piston 262 is fixedly connectable to the armature 246 and follow its movement, even if the support member 238 is axially fixed. In the position shown, the control piston 262 of the pilot valve 260 prevents fluid from passing from the inlet 204 towards the control surface 256 of the main valve 250.

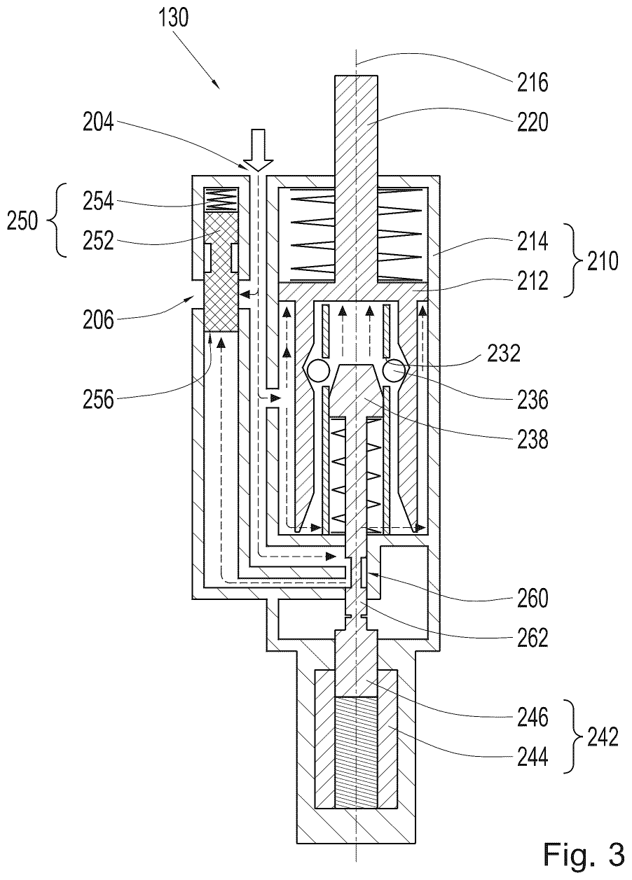

FIG. 3 shows the actuator 130 from FIG. 2 in a second position. An electric current flows through the coil 244, which induces a magnetic field, which pulls the armature 246 along the axis 216 relative to the position from FIG. 2 downward into the position shown.

The control piston 262, in its axial position, is axially displaced with respect to the position from FIG. 2. In the position shown, it permits fluid to pass from the inlet 204 to the control surface 256 of the main valve 250. Due to the hydraulic pressure of the fluid acting on the control surface 256, the control piston 252 is displaced axially upward against the force of the elastic element 254 in the schematic view from FIG. 3. As a result, the main valve 250 is in a blocking position, and the flow of fluid from the inlet 204 to the outlet 206 is interrupted.

Due to the interruption, a hydraulic pressure of the fluid at the inlet 204 may rise. Therefore, the hydraulic pressure in the working space of the hydraulic arrangement 210 may also increase, such that the piston 212 is driven upward with an increased force.

When the armature 246 is axially displaced, the support member 238 is also displaced downward. A radial support effect on the locking member 236 is nullified, such that the locking member is drivable radially inward due to the shape of the cutout 232, such that the form fit coupling between the cylinders 228, 230 is released.

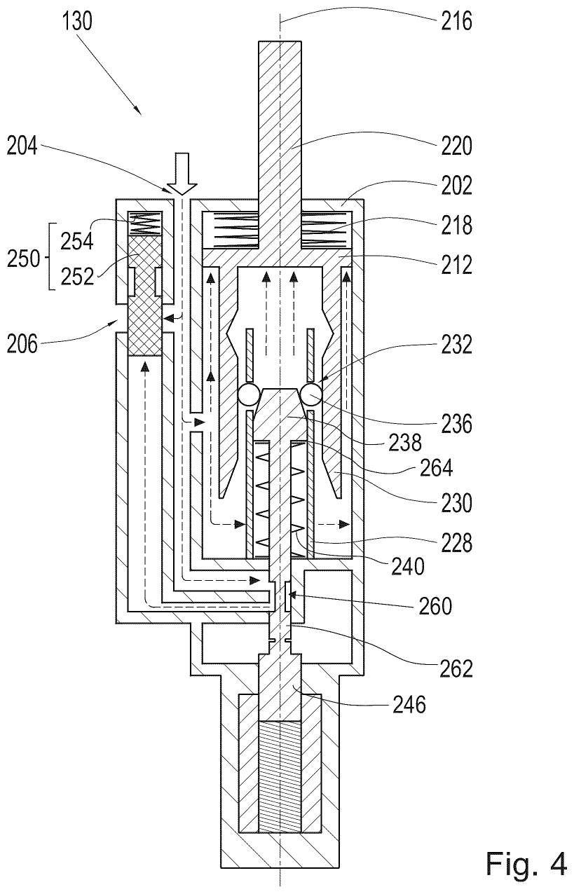

FIG. 4 shows the actuator 130 from FIG. 2 in a third position. The locking member 236 is driven radially inward and is still situated in the cutout 232. The form fit connection between the first cylinder 228 and the second cylinder 230 is released, and the hydraulic pressure in the working space of the hydraulic arrangement 210 has driven the piston 212 upward against the force of the elastic element 218, such that the piston rod 220 is displaced upward relative to the housing 202.

If the electric current through the coil 244 is switched off, the armature 246 is pressable upward again by the elastic element 240. The displacement body 238 cannot follow this movement, as the elastic decoupling mechanism 264 provides a decoupling. Due to the movement of the armature 246, the control piston 262 of the pilot valve 260 is brought into the closed position (cf. FIG. 2) and the control piston 252 of the main valve 250 drops due to the force of the elastic element 254, such that fluid may flow from the inlet 204 to the outlet 206 again.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

100 electric drive axle
105 motor vehicle
110 driving wheel
115 electrical propulsion unit
120 parking lock
125 pump
130 actuator
202 housing
204 hydraulic inlet
206 hydraulic outlet
210 hydraulic arrangement
212 piston
214 cylinder
216 axis
218 elastic element
220 push rod
226 locking mechanism
228 first cylinder
230 second cylinder
232 cutout
234 indentation
236 locking member
238 support member
240 elastic element
242 electromagnetic actuation
244 electrical coil
246 armature
250 first valve (main valve)
252 control piston
254 elastic element
256 control surface
260 second valve (pilot valve)
262 control piston
264 decoupling

1-11. (canceled)

12. An actuator (130) for a parking lock (120) in a motor vehicle, the actuator (130) comprising:
a hydraulic piston (212) in a cylinder (214), wherein the parking lock (120) is actuatable by the hydraulic piston (212);
a hydraulic inlet (204) hydraulically connected to the cylinder (214);
a form-fitting locking mechanism (226) for locking the hydraulic piston (212) in a predetermined position;
an electromagnetic actuation mechanism (242) for releasing the form-fitting locking mechanism (226);
a hydraulic outlet (206); and
a valve (250) in fluid flow between the hydraulic inlet (204) and the hydraulic outlet (206), the electromagnetic actuation mechanism (242) acts on the valve (250) such that the valve (250) is closed when the form-fitting locking mechanism (226) is released.

13. The actuator (130) of claim 12, further comprising a further valve (260), the further valve (260) being controllable by the electromagnetic actuation mechanism (242),
wherein the valve (250) has a hydraulic control mechanism (256), the further valve (260) being in fluid flow between the hydraulic inlet (204) and the hydraulic control mechanism (256).

14. The actuator (130) of claim 13, wherein the further valve (260) is open when the form-fitting locking mechanism (226) is released.

15. The actuator (130) of claim 13, wherein the electromagnetic actuation mechanism (242) comprises an electrical coil (244) and a movable armature (264).

16. The actuator (130) of claim 15, wherein the movable armature (264) is integrated with a control piston (262) of the further valve (260).

17. The actuator (130) of claim 12, further comprising an elastic decoupling mechanism between the electromagnetic actuation mechanism (242) and the form-fitting locking mechanism (226).

18. The actuator (130) of claim 12, further comprising:
a locking member (236); and
a support member (238) displaceable along an axis (216),
wherein the form-fitting locking mechanism (226) comprises a first element (228) and a second element (230), the first and second elements (228, 230) being displaceable relative to each other along the axis (216),
wherein the first element (228) has a cutout (232) and the second element (230) has an indentation (234), the locking member (236) being receivable in the cutout (232) and the indentation (234), and
wherein the locking member (236) is holdable in the indentation (234) by the support member (238) according to a position of the support member (238).

19. The actuator (130) of claim 18, wherein the first and second elements (228, 230) are concentric cylinders (228, 230),
wherein the support member (238) is in an inner cylinder (228) of the concentric cylinders (228, 230).

20. The actuator (130) of claim 19, wherein one of the concentric cylinders (228, 230) is connected to the hydraulic piston (212).

21. An electric drive axle (100), comprising a parking lock (120) and the actuator (130) of claim 12.

22. A motor vehicle (100), comprising the electric drive axle (100) of claim 21.
